(19) United States
(12) Patent Application Publication
(10) Pub. No.: US 2001/0007317 A1
(43) Pub. Date: Jul. 12, 2001

(54) COMPOSITION AND METHOD FOR STRIPPING TIN OR TIN ALLOYS FROM METAL SURFACES

(75) Inventors: RAYMOND LETIZE, WEST HAVEN, CT (US); ROBERT HAMILTON, TORRINGTON, CT (US)

Correspondence Address: JOHN L CORDANI, CARMODY & TORRANCE LLP, 50 LEAVENWORTH STREET, P.O. BOX 1110, WATERBURY, CT, 06702, US

(73) Assignee: MACDERMID, INCORPORATED

(21) Appl. No.: 09/251,644

(22) Filed: Feb. 17, 1999

(51) Int. Cl. C23F 1/00; H01B 13/00; C09K 13/06

(52) U.S. Cl. 216/13; 216/103; 216/105; 252/79.4

(57) ABSTRACT

Tin or tin alloys, and any underlying copper-tin intermetallic, are stripped from copper surfaces utilizing an aqueous solution comprising nitric acid, sulfamic acid and a mono, di, or tri hydroxyl benzene.

### BACKGROUND OF THE INVENTION

The present invention relates to compositions and methods for the stripping of tin or tin-lead alloys (i.e., solder) from copper or other metal surfaces, and more particularly to compositions and methods for treating tin-coated or solder-coated copper surfaces in the course of manufacture of printed circuit boards to strip the tin or solder therefrom and expose the underlying copper metal.

In the course of manufacturing printed circuit boards, it is commonplace to deposit a layer of tin or tin-lead alloy (solder) on all or selected conductive copper surfaces of the board defining traces, through-holes, surrounding pad areas and the like, to serve, for example, as an etch resist in the subsequent etching away of other copper surfaces of the board. In many cases, it is thereafter necessary to strip the tin or tin-lead alloy from all or selected copper surfaces coated therewith. For example, it often is necessary to strip tin or tin-lead from copper surfaces at selected board areas (e.g., contact fingers) so that the surfaces can be plated with nickel and/or gold, or it may be necessary to strip tin or tin-lead from copper surfaces so that a solder mask can be applied over a bare copper surface (so-called SMOBC processes). Oftentimes, it simply is necessary to strip tin or tin-lead from a reject piece as part of the process for recovering and reusing underlying copper material. Also, while particularly apropos of printed circuit board manufacture, the need to strip away tin or tin-lead layers from copper surfaces also arises in other contexts where tin or tin-lead has been applied over a copper surface for decorative and/or functional purposes.

In addition, when copper metal surfaces are coated with tin or tin-lead alloys, a thin layer or film of copper-tin alloy (or intermetallic) typically forms at the layer interface, which film progressively increases in thickness with time. Accordingly, in processes designed to strip away the tin or tin-lead layer to expose copper metal, it is necessary to insure that this copper-tin intermetallic also is removed.

Compositions designed to strip tin and/or tin-lead coatings from copper surfaces are known in the art. One class of such compositions includes those based upon hydrogen peroxide and hydrofluoric acid or a fluoride. See, e.g., U.S. Pat. Nos. 3,926,699; 3,990,982; 4,297,257; 4,306,933; 4,374,744 and 4,673,521. Another class involves those employing nitro-substituted aromatic compounds as a principal ingredient, often in conjunction with an inorganic acid (see, e.g., U.S. Pat. Nos. 3,677,949; 4,004,956; 4,397,753; and 5,035,749) or an organic acid (see U.S. Pat. No. 4,439,338 disclosing the use of alkylsulfonic acids). Other known stripper compositions and processes are described in U.S. Pat. Nos. 4,424,097 and 4,687,545. Nitric acid-based strippers also have long been used in the art. See, e.g., the discussion in U.S. Pat. No. 4,713,144, and the use therein of a composition of nitric acid, sulfamic acid and ferric nitrate; see also U.S. Pat. Nos. 4,919,752; 4,964,920 and 5,244,539 relating to nitric acid-based strippers.

Difficulties arise with all these known stripper compositions. The peroxide-fluoride system is very exothermic and, unless the solution is cooled continuously, temperatures are quickly reached where the peroxide decomposes. Also, the system is highly aggressive, running risk of attack on the copper and, as a result of the fluoride, attack of the glass typically present in the glass-reinforced substrates (e.g., epoxy-glass) used in printed circuit manufacture. Still a further problem with the use of peroxide-fluoride systems in the stripping of tin-lead alloys is the formation of a large volume of lead fluoride sludge which eventually interferes with stripping, requires frequent cleaning of tanks and equipment, and poses significant waste disposal problems.

Strippers based upon nitro-substituted aromatic compounds are prone to redeposition of tin onto the copper from the stripping bath, which can be difficult to remove without excessive attack on the copper, and also are plagued by sludge formation. Nitric acid-based strippers generally form large volumes of sludge which, apart from the above-noted problems, can become adhered to the surfaces of the copper or to the printed circuit board substrate. Still further, most such systems require two-step processing in order to insure removal of copper-tin intermetallic residing on the copper surface after first removal of tin or tin-lead.

The formation of sludges and the highly corrosive nature of many of these stripper solutions also generally limits their practical use to processes where the surfaces to be treated are dipped or immersed in the solution, i.e., they are incompatible with the equipment which would be used to apply the solutions by a spraying technique.

In U.S. Pat. No. 4,957,653, the disclosure of which is incorporated herein by reference, there are described improved compositions for the stripping of tin or tin-lead alloy, as well as any underlying copper-tin alloy, from a copper surface, the compositions being comprised of an aqueous solution of an alkane sulfonic acid and ferric nitrate. Also incorporated herein by reference are the disclosures of related U.S. Pat. Nos. 4,944,851 and 4,921,571 directed, respectively, to electrolytic means for regenerating such alkane sulfonic acid/ferric nitrate compositions and to the inclusion in such compositions of inhibitors which minimize attack on the underlying copper surface. Among the outstanding advantages associated with these alkane sulfonic acid/ferric nitrate compositions is their ability to rapidly remove tin or tin-lead, and any underlying copper-tin alloy, from copper surfaces in a single application process (e.g., either immersion or spraying) without concomitant formation of any appreciable sludge or precipitate.

Despite the outstanding effectiveness of these alkane sulfonic acid-based stripping compositions, they are subject to the commercial problem of being relatively expensive, largely attributable to the high cost of the alkane sulfonic acids, such as methane sulfonic acid (MSA). U.S. Pat. No. 5,017,267 also incorporated herein by reference, addresses this problem and provides at least a partial solution thereto by utilizing a source of chlorate ion as a means for reducing the quantity of alkane sulfonic acid normally required. For example, a methane sulfonic acid/ferric nitrate/nitric acid composition normally requiring 540 g/l of 70% MSA can be reformulated with inclusion of 40 g/l sodium chlorate and reduction of MSA to 270 g/l without loss of stripping effectiveness. Given the high cost of MSA and other alkane sulfonic acids, however, these compositions with reduced MSA concentration still are relatively expensive, and it would be highly desirable to provide yet a lower cost formulation which nevertheless still provides the advantages and attributes of these more expensive systems.

### SUMMARY OF THE INVENTION

The primary object of the present invention is to provide a composition for stripping tin or tin-lead alloy, as well as any underlying copper-tin intermetallic, from a copper or other metallic surfaces, which composition effects such stripping rapidly and in a single application, without any appreciable formation of sludge or precipitate, and which composition has the further characteristic of being capable of relatively low-cost formulation.

In accordance with the present invention, these and other objects are attained by the use of a composition for stripping tin or tin-lead wherein the composition comprises:

a. nitric acid;

b. sulfamic acid; and

c. a material selected from the group consisting of hydroxyl benzene, dihydroxyl benzene, trihydroxyl benzene and mixtures of the foregoing.

Quite surprisingly, it has been found that the foregoing composition rapidly and efficiently strips tin or tin-lead, and any copper-tin intermetallic, from copper surfaces, without any significant attack upon the copper surface and without any significant formation of sludge or precipitate.

### DETAILED DESCRIPTION OF THE INVENTION

In accordance with the invention, compositions and processes are provided for stripping tin or tin-lead (solder), and any underlying copper-tin intermetallic, from copper or other metallic surfaces.

As previously noted, compositions of this type are particularly useful in the environment of printed circuit board manufacture where copper circuitry on an insulating substrate has been provided with a tin or tin-lead layer (e.g., by immersion plating, electroplating, etc.) incident to the manufacturing process, but then is required to be removed from all or some of the copper surfaces as a further step in manufacture and/or simply in an effort to reclaim copper from a reject board. Generally, the tin or tin-lead layer over the copper will be on the order of 0.0002 to 0.0004 inches thick (0.2 to 0.4 mils) in typical circuit board manufacturing processes. Moreover, a thin layer or film of copper-tin intermetallic will form between the copper and the tin or tin-lead layers, generally having a thickness of about 0.002 to about 0.004 mils, which thickness increases with time. The invention is generally applicable, however, to the removal of tin or tin-lead, and any underlying copper-tin intermetallic, from any copper surface on which the tin or tin-lead has previously been applied, whether or not in the context of printed circuit board manufacture and whether or not the copper in turn is associated with some underlying insulating or conductive substrate.

The invention is applicable to the treatment of copper surfaces on which essentially pure tin metal has been deposited or, as is more common, copper surfaces on which tin-lead alloy has been deposited. Tin-lead alloys are interchangeably referred to herein as solder, and may range in tin content from about 1 to 99% by weight, with the balance lead, although most solders commercially employed have a weight ratio of tin:lead of about 60:40. Many such alloys also contain relatively minor amounts of additional metallic species which do not in any event affect the efficacy of the stripping compositions of the invention.

According to the invention, the essential components of the stripper composition are nitric acid, sulfamic acid and dihydroxyl benzene. The composition proposed thus comprises:

a). nitric acid;

b). sulfamic acid; and

c). a material selected from the group consisting of hydroxyl benzene, di-hydroxyl benzene, tri-hydroxyl benzene and mixtures of the foregoing.

The nitric acid type typically will be present in the aqueous solution in a concentration in the range of from 30 g/l to 600 g/l, more preferably a concentration in the range of from 100 g/l to 400 g/l, and most preferably a concentration in the range of from 250 g/l to 350 g/l. These concentrations are given in terms of nitric acid per se, but typically the composition of the invention will be made up using a 69-70 weight percent solution of nitric acid, which is a readily available commercial form thereof.

The sulfamic acid typically will be present in the aqueous solution in a concentration in the range of from 1 gr/l to 20 gr/l, more preferably a concentration in the range of from 2 gr/l to 10 gr., and most preferably a concentration in the range of from 4 gr/l to 6 gr/l.

The various hydroxyl benzenes (mono, di, and tri) typically will be present in the aqueous solution in a concentration in the range of from 0.1 gr/l to 10 gr/l, more preferably a concentration in the range of from 0.5 gr/l to 5 gr/l, and most preferably a concentration in the range of from 1 gr/l to 3 gr/l. As indicated hydroxyl benzene, di-hydroxyl benzene, and trihydroxyl benzene are useful in the foregoing concentrations in the composition of this invention. Di-hydroxyl benzenes are preferred. Hydroquinone or para-hydroxyl phenol is the most preferred form of di-hydroxyl benzene useful in the invention. However meta-hydroxyl phenol and ortho hydroxyl-phenol (catechol) are also useful.

It is preferred for the composition to comprise a source of ferric ions. Ferric ions assist in the removal of any copper-tin intermetallic layer. The most preferred source of ferric ions is ferric nitrate. The concentration of ferric ions in the composition will preferably range from 5 gr/l to 25 gr/l and most preferably from 10 gr/l to 20 gr/l.

In the most preferred compositions of the invention, the aqueous solution also will contain an inhibitor which is effective to minimize the possibility of attack of the underlying copper surface during the stripping process, but without substantially affecting the essential characteristics and properties of the stripping solution, i.e., stripping speed, stripping efficiency, no significant formation of sludge or precipitate, ease of waste treatment and the like. Among the suitable inhibitors are those disclosed in U.S. Pat. No. 4,921,571, incorporated herein by reference. Most preferred inhibitors are quaternary ammonium compounds, block copolymers of ethylene and propylene oxide, and ethoxylated alkylphenols (e.g., octyl or nonyl phenols), and mixtures thereof. The inhibitor typically will be used at relatively low concentrations, on the order of from about 0.01 g/l to about 5 g/l, but some inhibitors can be employed at higher concentrations, up to about 50 g/l, without adverse effect on stripping speed.

For employing the compositions of the invention to treat tin or solder-coated copper surfaces to remove the tin or solder therefrom, along with any copper-tin intermetallic, so as to expose the copper metal, the surfaces in question are either immersed in the aqueous composition or the composition is sprayed on the surfaces. For typical tin or tin-lead and copper-tin layer thicknesses as earlier described, complete removal generally can be effected after from one to three minutes immersion, or upon spraying for anywhere from about 10 to 30 seconds. For spraying, the aqueous composition is typically continuously recirculated, and of course, for spraying or immersion processes, the aqueous composition can be used to treat a multitude of tin or tin-lead coated copper surfaces simultaneously or sequentially until such time as the stripping efficiency of the solution becomes economically low.

The compositions of the invention can be employed at temperatures of from room temperature to about 150° F.

The invention is further described and illustrated with reference to the following examples.

### EXAMPLE I

An aqueous solution was prepared containing 315 g/l of nitric acid, 65 gr/l of ferric nitrate, 2 gr/l hydroquinone and 1 g/l of benzatriazole to serve as an inhibitor. The solution, at room temperature, was used to strip tin-lead (0.3 mils)-coated copper panels in an immersion process. The time needed for producing a clean copper surface free of tin-lead and copper-tin intermetallic was on the order of about 1-3 minutes. The solution was employed in stripping a multitude of panels to a point where the solution contained 20 oz./gallon of metals, at which stage no sludge or precipitate were evident in the solution. Attack of the copper surface of the panels was negligible.

It is to be understood that while the invention has been described and illustrated with reference to particular features and embodiments, these do not constitute limitations of the scope of the invention except to the extent recited in the appended claims.

What is claimed is:

1. A composition for stripping tin or tin alloys from a metallic surface, said composition comprising:
a) nitric acid;
b) sulfamic acid; and
c) a material selected from the group consisting of hydroxyl benzene, di-hydroxyl benzene, tri-hydroxyl benzene and mixtures of the foregoing.

2. A composition according to claim 1 wherein the metallic surface comprises copper.

3. A composition according to claim 1 wherein the material is hydroquinone.

4. A composition according to claim 2 wherein the material is hydroquinone.

5. A composition according to claim 2 wherein the concentration of nitric acid is in the range of 250 gr/l to 350 gr/l, the concentration of sulfamic acid is in the range of 4 gr/l to 6 gr/l and the concentration of material is in the range of 1 gr/l to 3 gr/l.

6. A composition according to claim 2 wherein the composition also comprises ferric ions.

7. A composition according to claim 5 wherein the material is hydroquinone.

8. A process for stripping tin or tin alloys from a metallic surface, said process comprising contacting said metallic surface with a solution comprising:
a). nitric acid;
b). sulfuric acid; and
c). a material selected from the group consisting of hydroxyl benzene, di-hydroxyl benzene, tri-hydroxyl benzene, and mixtures of the foregoing.

9. A process according to claim 8 wherein the metallic surface comprises copper.

10. A process according to claim 8 wherein the material is hydroquinone.

11. A process according to claim 9 wherein the material is hydroquinone.

12. A process according to claim 9 wherein the concentration of nitric acid is in the range of 250 gr/l to 350 gr/l, the concentration of sulfamic acid is in the range of 4 gr/l to 6 gr/l and the concentration of material is in the range of 1 gr/l to 3 gr/l.

13. A process according to claim 9 wherein the solution also comprises ferric ions.

14. A process according to claim 12 wherein the material is hydroquinone.
